(19) United States
(12) Patent Application Publication
(10) Pub. No.: US 2009/0145532 A1
(43) Pub. Date: Jun. 11, 2009

(54) Method of Manufacturing A Carcass Ply

(75) Inventors: Tetsuo Tatara, Osaka (JP); Tomoyuki Takatsuka, Osaka (JP); Hirokatsu Mizukusa, Osaka (JP); Osamu Fujiki, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 11/995,391

(22) PCT Filed: Jul. 15, 2005
(86) PCT No.: PCT/JP2005/013160

§ 371 Date: Jan. 11, 2008

(51) Int. Cl. B60C 9/02; B29D 30/20

(52) U.S. Cl. 152/548; 156/117

(57) ABSTRACT

A large-width ply base material 30a and a small-width ply base material 30b, which have different width dimensions, are standard-length cut, a plurality of strip plies 26 being at least one of large-width strip plies 26a and small-width strip plies 26b thus obtained are used, non-cut surface sides of the respective strip plies 26 are joined together to build a band-shaped ply member 28, and the ply member 28 is wound round a building drum 50 in a tensioned state, in which the tensile rate is equal to or less than 3%.

### TECHNICAL FIELD

The present invention relates to a method of manufacturing a carcass ply, which constitutes a carcass layer of, for example, a radial tire, and mainly to a method of manufacturing a carcass ply, in which production of various kinds can be performed efficiently.

### BACKGROUND ART

Conventionally, in manufacturing a carcass ply of a pneumatic radial tire, calender treatment is first performed so as to impregnate an unvulcanized rubber on a multiplicity of reinforcement cords as aligned, thus manufacturing a ply base material.

Subsequently, the ply base material is standard-length cut to strip plies having a length corresponding to a tire width. The strip plies thus cut are connected together in a direction along a tire circumferential direction to be wound as a band-shaped ply member in a rolled manner to be once stocked.

When a carcass ply is to be built, the band-shaped ply member is taken out from a roll to be conveyed, and cut to a length corresponding to a desired tire circumferential length to be then stuck to a building drum, thus performing ply building.

Since a carcass layer of a tire is varied in length and width depending upon a tire size, however, it is necessary to prepare rolls of various kinds, round which a lengthy ply member being different every tire specifications is wound, thus causing a problem of the necessity for a wide stock space, in which rolls of various kinds are stocked. Also, since diversion of rolls of other tire specifications is not possible, it is necessary to exchange a roll whenever tire specifications are changed, and a work manhour therefor becomes great to cause a problem that it is difficult to conform to production of various kinds and small lot.

Patent Documents 1 described later discloses the technology of building a carcass ply such that a plurality of strip plies obtained by standard-length cutting a ply base material, which has a width dimension being integral times π inch, to a length corresponding to a tire width are respectively stuck sequentially to a whole peripheral surface of a building drum, which has an outer peripheral length being integral times π inch, in a posture, in which both side edges are made parallel to an axis of the building drum, and respective side end surfaces of the respective strip plies adjacent to one another in a circumferential direction of the building drum are butted against one another to be joined.

Thereby, it is possible to just cover whole outer peripheral surfaces of building drums of various kinds without switching of width dimensions of strip plies, so that rolls of various kinds having different width dimensions are dispensed with, thus enabling solving the problem.

By the way, a belt layer, tread rubber, etc. are wound annularly round a building drum, round which a ply member is wound to form a carcass layer, to build a cylindrical-shaped green tire, and the green tire is brought into pressure contact with a concave die inner surface at high inner pressure to be cured and built into a toroidal-shaped radial tire, at which the ply member, the belt layer, etc. wound round the building drum are expanded and deformed in a manner to be increased in diameter as it goes central in a tire width direction.

Since fabric cords and steel cords are normally used for reinforcement cords used for a carcass layer and a belt layer, reinforcement cords are not elongated at the time of an increase in diameter, so that in some cases the carcass layer and the belt layer are deformed in width between the reinforcement cords as they go centrally and a sufficient tire strength is not obtained when widths between the reinforcement cords are excessively increased.

Therefore, according to tire specifications, an outer peripheral length of a building drum is restricted by a demand for such tire strength and cannot be set to integral times π inch in some cases, so that there is caused in such case a problem that the technology disclosed in Patent Documents 1 does not enable strip plies to just cover a whole peripheral surface of the building drum.

Also, even in the case where an outer peripheral length of a building drum can be made integral times π inch, there is caused, in case of winding a plurality of ply members to provide for a multi-layered structure, a problem that even when a first layer can cover just a whole peripheral surface of the building drum, a second layer and succeeding layers cannot cover just the whole peripheral surface due to a thickness of the ply members, which constitute layers thereunder.

Also, in the case where the circumferential length of the building drum is prime times π inch, such as 17π or 19π or the like, that is, in the case where a tire size is prime inch, strip plies cannot but have a width size of 1π inch and so strip plies as stock are increased in number to lead to an increase in manufacturing process to cause a problem.

[Patent Documents 1] JP-A-4-226742

### DISCLOSURE OF THE INVENTION

### Problems that the Invention is to Solve

The invention has been thought of in view of the problems and has its object to provide a method of manufacturing a carcass ply, in which a strip ply can be built on a building drum having an optional outer peripheral length without changing a width of the strip ply and production of various kinds and small lot can be performed efficiently.

### Means for Solving the Problems

A method of manufacturing a carcass ply, according to the invention, is a method of manufacturing a carcass ply, which constitutes a carcass layer of a tire, the method comprising standard-length cutting a large-width ply base material and a small-width ply base material, which have different width dimensions, using a plurality of strip plies being at least one of large-width strip plies and small-width strip plies thus obtained, joining non-cut surface sides of the respective strip plies to build a band-shaped ply member, and winding the ply member round a building drum in a tensioned state, in which the tensile rate is equal to or less than 3%.

In this manner, by appropriately setting large-width strip plies and small-width strip plies in width dimension, a ply member can cover a whole peripheral surface of a building drum having an optional outer peripheral length without changing a width of the respective strip plies and while restricting the number of strip plies as stock. Therefore, it is possible to conform to production of various kinds and small lot with different tire sizes and to restrict times, at which strip plies are joined, thus enabling manufacture at low cost. Besides, since the plymember is wound round the building drum in a tensioned state, in which the tensile rate is equal to or less than 3%, ply members having the same length can cover a whole peripheral surface of the building drum even in case of winding a plurality of ply members to form a carcass layer having a multi-layered structure. Therefore, it is not necessary to prepare ply members of many kinds and to dispense with a stock space for stocking them.

Also, in the invention, the ply member may be joined in a state, in which non-cut surface sides of those strip plies, which constitute the ply member, overlap together a predetermined amount. In this case, since it is possible to adequately ensure the bond strength for the respective strip plies, it is possible to suppress breakage of a ply member when the ply member is wound round a building drum in a tensioned state.

### EFFECT OF THE INVENTION

As described above, according to the invention, a ply member can cover a whole peripheral surface of a building drum having an optional outer peripheral length without changing a width of a strip ply, so that it is possible to conform to production of various kinds and small lot and to restrict the number of strip plies as stock, thus enabling manufacture at low cost.

### BEST MODE FOR CARRYING OUT THE INVENTION

Subsequently, an embodiment of the invention will be described in detail with reference to the drawings.

FIG. 1 is a cross sectional view showing a pneumatic tire according to the embodiment of the invention, FIG. 2 is a view showing a ply member 28, and FIGS. 3 to 5 are views illustrating essentials of a method of manufacturing a carcass ply.

FIG. 1 shows an example of a pneumatic radial tire (referred below to as tire) 10 according to the embodiment, the reference numeral 12 denotes an inner liner portion, 14 a tread portion, 16 side wall portions, and 18 bead portions. A carcass layer 20 formed by laminating two-layered carcass plies 20a, 20b is arranged on an outer peripheral side of the inner liner portion 12 arranged on a tire inner side, both ends of the carcass layer being folded outside from the tire inner side in a manner to interpose bead cores 22.

As shown in FIGS. 2(a) and 2(b), the respective carcass plies 20a, 20b are composed of a band-shaped ply member 28 formed by joining an integral number of strip plies 26 obtained by cutting a lengthy band-shaped ply base material, which is subjected to calender treatment so as to impregnate an unvulcanized rubber on a plurality of reinforcement cords C as aligned, the reinforcement cords C being made substantially perpendicular to a circumferential direction T of a tire 10.

Specifically, the strip plies 26 comprise two kinds of large-width strip plies 26a and small-width strip plies 26b, which are in the form of a rectangular strip, major sides of which are equal to each other in lengthy dimension, and minor sides of which are different in lengthy dimension (that is, width dimension) from each other. A predetermined number of large-width strip plies 26a and a predetermined number of small-width strip plies 26b are used and the respective strip plies 26 are joined with side edge portions of major sides thereof overlapping each other a predetermined amount whereby the ply member 28 forms a single tire circumference. In addition, in FIG. 2(a), Wa indicates a width dimension of the large-width strip plies 26a, Wb indicates a width dimension of the small-width strip plies 26b, and P indicates an overlap width provided on the respective strip plies 26a, 26b.

A belt layer 24 formed by laminating two layer belt plies 24a, 24b made of steel cord at an angle in a tire circumferential direction is provided on an outer peripheral side of the carcass layer 20 of the tread portion 14.

With the tire 10 structured in this manner, an inner liner rubber is wound round an outer peripheral surface of a building drum 50 in a normal method to form the inner liner portion 12, and then the two layer carcass plies 20a, 20b, which constitute the carcass layer 20, are built as shown in FIGS. 3 to 5.

In FIGS. 3 to 5, the reference numeral 52 denotes a strip roll, round which a large-width ply base material 30a is wound in a rolled manner, and 54 a strip roll, round which a small-width ply base material 30b is wound in a rolled manner. The reference numerals 56, 58, respectively, denote transfer conveyors for the respective ply base materials 30a, 30b continuously taken out from the strip rolls 52, 54. The reference numerals 60, 62, respectively, denote standard-length cut conveyors, which receive the respective ply base materials 30a, 30b as conveyed on downstream sides of the transfer conveyors 56, 58 in a feed direction to cut the same to large-width strip plies 26a and small-width strip plies 26b, both of which have predetermined lengths, to temporarily stock the same. As shown in FIG. 4, cutters 64, 66 for standard-length cut are provided on the standard-length cut conveyors 60, 62. In addition, a construction will do, in which the transfer conveyors 56, 58 are omitted and the standard-length cut conveyors 60, 62 serve as transfer conveyors.

The reference numeral 68 denotes a sticking conveyor, to which the respective strip plies 26a, 26b stocked on the standard-length cut conveyors 60, 62 are transferred and on which the respective strip plies 26a, 26b are joined with side edge portions on non-cut surface sides thereof overlapping each other a predetermined amount to build the ply member 28, the sticking conveyor 68 being arranged with a feed direction F1 of the sticking conveyor 68 perpendicular to a feed direction F2 of the standard-length cut conveyors 60, 62, and the ply member 28 on the sticking conveyor 68 being conveyed to the building drum 50. While depiction is omitted, a push device for pushing overlapped portions of the strip plies 26a, 26b is provided on the sticking conveyor 68.

The reference numeral 70 denotes a strip ply transfer device, by which the strip plies 26a, 26b cut to standard lengths by the cutters 64, 66 are transferred to the sticking conveyor 68. The strip ply transfer device 70 includes gripping means 74, which grips the strip plies 26a, 26b cut to standard lengths mainly with vacuum attraction, and transfer means 78, which moves the gripping means 74 up and down with means such as a cylinder device, etc. and moves the gripping means between the standard-length cut conveyors 56, 58 and the sticking conveyor 68, so that the strip plies 26a, 26b stocked on the standard-length cut conveyors 60, 62 can be gripped by the gripping means 74 to be transferred onto the sticking conveyor 68.

The reference numeral 82 denotes a ply member transfer device, by which the ply member 28 formed on the sticking conveyor 68 by joining the strip plies 26a, 26b together is conveyed onto the outer peripheral surface of the building drum 50, the ply member transfer device including, like the strip ply transfer device 70 described above, gripping means 84, which grips the ply member 28 with vacuum attraction, and transfer means 86, which moves the gripping means 84 up and down and moves the gripping means between the sticking conveyor 68 and the building drum 50.

In addition, the structure of and rotary drive means for the building drum 50, or centering means and positioning means for sticking the ply member 28 on the sticking conveyor 68 to a predetermined position on the building drum 50, are the same as those in a conventional art.

In building the respective carcass plies 20a, 20b, a large-width ply base material 30a and a small-width ply base material 30b, which have width dimensions equal to width dimensions Wa, Wb of the large-width strip ply 26a and the small-width strip ply 26b, are continuously taken out from the strip rolls 52, 54 and conveyed via the transfer conveyors 56, 58 to the standard-length cut conveyors 60, 62 arranged downstream thereof in the feed direction.

In the standard-length cut conveyors 60, 62, the large-width ply base material 30a and the small-width ply base material 30b as conveyed are standard-length cut to the large-width strip plies 26a and the small-width strip plies 26b, which have a predetermined length corresponding to a tire width. The large-width ply base material 30a and the small-width ply base material 30b as cut are temporarily stocked on the standard-length cut conveyors 60, 62 as they are. At this time, the standard-length cut conveyors 60, 62 do not perform feeding motion and the transfer conveyors 56, 58 temporarily stop transfer.

On the other hand, the strip ply transfer device 70 transfers the large-width strip plies 26a and the small-width strip plies 26b, respectively, by a predetermined number to the sticking conveyor so as to make the ply member 28 having a predetermined length.

Specifically, the strip ply transfer device 70 stops in a position above a predetermined standard-length cut conveyor (here, the standard-length cut conveyor 60, on which a large-width strip ply 26a is stocked), on which a large-width strip ply 26a or a small-width strip ply 26b as cut in the manner described above is stocked, the gripping means 74 on the strip ply transfer device 70 descends to grip the large-width strip ply 26a on the standard-length cut conveyor 60 and ascends in this state to move to a position above the sticking conveyor 68 to stop, and the gripping means 74 descends and releases grip whereby the large-width strip ply 26a is transferred onto the sticking conveyor 68. The large-width strip ply 26a transferred onto the sticking conveyor 68 in this manner is conveyed on the sticking conveyor 68 so that a side edge portion on a non-cut surface side thereof comes to a predetermined sticking position.

Also, the standard-length cut conveyor 60, on which a large-width strip ply 26a is transferred onto the sticking conveyor 68 and not stocked, is standby for a next transfer such that the large-width ply base material 30a is again taken out from the strip roll 52 to be conveyed and received and cut by the standard-length cut conveyor 60 and large-width strip ply 26a as standard-length cut is temporarily stocked.

Subsequently, the strip ply transfer device 70 transfers a small-width strip ply 26b onto the sticking conveyor 68 from a predetermined standard-length cut conveyor (here, the standard-length cut conveyor 62, on which a small-width strip ply 26b is stocked), on which a large-width strip ply 26a or a small-width strip ply 26b is stocked. At this time, the small-width strip ply 26b is transferred so that a side edge portion on a non-cut surface side thereof overlaps by a predetermined amount the side edge portion on the non-cut surface side of the large-width strip ply 26a as previously transferred, and the overlapping portions are pushed by the push device to be joined together.

The sticking conveyor 68 conveys the large-width strip ply 26a and the small-width strip ply 26b, which are joined together, so that the side edge portion on the non-cut surface side of the small-width strip ply 26b comes to a predetermined sticking position.

Also, the small-width ply base material 30b is again taken out from the strip roll 54 to be conveyed, and received and cut by the standard-length cut conveyor 62, and a small-width strip ply 26b as standard-length cut is temporarily stocked on the standard-length cut conveyor 62.

Thereafter, transfer of the strip ply on a predetermined standard-length cut conveyor by the strip ply transfer device 70, joining by the push device, conveyance of the joined strip plies on the sticking conveyor 68, and stock of the strip ply 26 as transferred are repeatedly performed to join respective, predetermined numbers of large-width strip plies 26a and small-width strip plies 26b in a state, in which side edge portions on non-cut surface sides thereof overlap each other by a predetermined amount, thus building a ply member 28 having a predetermined length corresponding to a single tire circumference on the sticking conveyor 68.

Here, “a length corresponding to a single tire circumference” means a length amounting to at least 97% but at most 100% of a length of the ply member 28 wound round the building drum 50, for example, a length of an outer periphery of the building drum 50, round which an inner liner rubber is wound, for that ply member 28, which constitutes a first-layer carcass ply 20a, and a length amounting to at least 97% but at most 100% of a length of an outer periphery of the building drum 50 in a state, in which a first ply member 28 is wound to form a first-layer carcass ply 20a, for that ply member 28, which constitutes a second-layer carcass ply 20b.

Also, “respective, predetermined numbers” includes not only the case where both the large-width strip plies 26a and the small-width strip plies 26b are used to build a ply member 28, but also the case where only either of the strip plies is used in predetermined number to form a ply member 28.

The gripping means 84 of the ply member transfer device 82 grips an end of the ply member 28 as built on a side toward the building drum 50 and the transfer means 86 moves the gripping means 84 to the building drum 50, whereby the ply member 28 is transferred onto the outer periphery of the building drum 50, round which an inner liner rubber is wound, to be wound so as to cover the whole outer peripheral surface thereof, and thus a first-layer carcass ply 20a is built. As described above, since the ply member 28 has a length amounting to at least 97% but at most 100% of a length wound round the building drum 50, it is wound round the building drum 50 in a tensioned state with a tensile rate R, which is defined by the following formula, being equal to or less than 3%.

R=(L−l)/L×100 [Formula 1]

Here, the character l indicates a length of the ply member 28 and L indicates a length of the ply member 28 wound round the building drum 50.

In some cases, the inner liner portion 12 is made protuberant at both ends thereof by a reinforcement rubber, such as rubber chafer, etc., wound round an underlayer and a little large in peripheral length as compared with the remaining portion. In such case, when it is tried to wind the ply member 28 in a tensioned state, overlap of the ply member 28 is generated on portions except both ends thereof. Such overlap becomes conspicuous since the ply member 28 as wound comes into close contact with the inner liner portion 12 as the tensile rate R increases. When the tensile rate R becomes larger than 4%, the reinforcement cords C in the ply member 28 are increased in spacing, so that a decrease in tire strength is caused and irregularities attributable to overlap of the ply member 28 appear on the side wall portions 16 of a tire after being cured and built, thus marring a fine view.

Therefore, the ply member 28 is wound round the building drum 50 in a tensioned state with the tensile rate R being equal to or less than 4%, more specifically, equal to or less than 3%. In such case, irregularities do not appear on side wall portions 16 of a tire after being cured and built, so that a fine view is not marred.

Like the first-layer carcass ply 20a, a predetermined number of strip plies 26 are joined together to build a ply member 28 and the ply member is wound round the outer peripheral surface of the building drum 50, round which the first-layer carcass ply 20a is wound, to build a second-layer carcass ply 20b in a tensioned state with the tensile rate R being equal to or less than 3%.

After the two carcass plies 20a, 20b are formed, a bead core and a side wall rubber are stuck in a conventional method to build a carcass band, the carcass band is deformed into a toroidal shape by a shaving drum, and a belt-tread laminate obtained by winding a tread rubber round the belt layer 24 as beforehand built is transferred to an outer peripheral surface of the carcass band. A stitcher is used to stick the belt tread laminate to the toroidal-shaped carcass band without a gap to build a green tire. The green tire is cured and built in a metallic die to enable obtaining a tire 10.

An embodiment of the invention is shown below but the invention is not limited thereto.

In the invention, the following TABLE 2 shows a tensile rate R when a ply member built as described above is wound in one to three layers round respective building drums, which correspond to tire sizes every inch from 15 to 22 inches, to form a carcass ply, for example, in the case where large-width strip plies 26a have a width Wa of 249 mm and small-width strip plies 26b have a width Wb of 166 mm.

In addition, Na indicates the number of large-width strip plies 26a as used, Nb indicates the number of small-width strip plies 26b as used, l indicates a length of a ply member built with the use of respective predetermined numbers of large-width strip plies 26a and small-width strip plies 26b, and an overlap width P of the respective strip plies is 3.6 mm. L indicates a length, over which a ply member 28 is wound round a building drum, and indicates, in the embodiment, a length obtained by adding a length of the overlap width P to an outer peripheral length of a building drum, round which an inner liner rubber is wound, for a first-layer carcass ply, and a length obtained by adding a length of the overlap width P to an outer peripheral length of a building drum in a state, in which first-layer and second-layer carcass plies are formed, for second-layer and third-layer carcass plies, since winding is performed with an overlap width equal to an overlap width P of the respective strip plies and both ends of a ply member are joined together.

Also, respective outside diameters of building drums used for respective tire sizes are 415 mm (16.3 inch), 440 mm inch), 471 mm (18.5 inch), 496 mm (19.5 inch), 522 mm inch), 547 mm (21.5 inch), 572 mm (22.5 inch), and 598 mm (23.5 inch), and all outer peripheral lengths thereof are not multiples of π inch.

TABLE 2

| | | | NUMBER OF | NUMBER OF | | | |
|---|---|---|---|---|---|---|---|
| | DIAMETER | | LARGE-WIDTH | SMALL-WIDTH | LENGTH OF | | |
| | OF BUILDING | NUMBER OF CARCASS | STRIP PLIES AS | STRIP PLIES AS | PLY | WOUND | TENSILE |
| TIRE SIZE | DRUM | LAYERS AS | USED: Na | USED: Nb | MEMBER: I | LENGTH: L | RATE: R |
| (inch) | (mm) | LAMINATED | (NUMBER) | (NUMBER) | (mm) | (mm) | (%) |
| 15 | 415 | FIRST LAYER | 4 | 2 | 1309.9 | 1319.9 | 0.76 |
| | | SECOND LAYER | 4 | 2 | 1309.9 | 1332.5 | 1.70 |
| | | THIRD LAYER | 4 | 2 | 1309.9 | 1345.1 | 2.62 |
| 16 | 440 | FIRST LAYER | 5 | 1 | 1392.9 | 1398.5 | 0.40 |
| | | SECOND LAYER | 5 | 1 | 1392.9 | 1411.0 | 1.28 |
| | | THIRD LAYER | 5 | 1 | 1392.9 | 1423.6 | 2.16 |
| 17 | 471 | FIRST LAYER | 6 | 0 | 1475.9 | 1495.9 | 1.34 |
| | | SECOND LAYER | 6 | 0 | 1475.9 | 1508.4 | 2.15 |
| | | THIRD LAYER | 6 | 0 | 1475.9 | 1521.0 | 2.97 |
| 18 | 496 | FIRST LAYER | 5 | 2 | 1555.3 | 1574.4 | 1.21 |
| | | SECOND LAYER | 5 | 2 | 1555.3 | 1587.0 | 2.00 |
| | | THIRD LAYER | 5 | 2 | 1555.3 | 1599.5 | 2.76 |
| 19 | 522 | FIRST LAYER | 6 | 1 | 1638.3 | 1656.1 | 1.07 |
| | | SECOND LAYER | 6 | 1 | 1638.3 | 1668.7 | 1.82 |
| | | THIRD LAYER | 6 | 1 | 1638.3 | 1681.2 | 2.55 |
| 20 | 547 | FIRST LAYER | 7 | 0 | 1721.3 | 1734.6 | 0.77 |
| | | SECOND LAYER | 7 | 0 | 1721.3 | 1747.2 | 1.48 |
| | | THIRD LAYER | 7 | 0 | 1721.3 | 1759.8 | 2.19 |
| 21 | 572 | FIRST LAYER | 6 | 2 | 1800.7 | 1813.2 | 0.69 |
| | | SECOND LAYER | 6 | 2 | 1800.7 | 1825.7 | 1.37 |
| | | THIRD LAYER | 6 | 2 | 1800.7 | 1838.3 | 2.04 |
| 22 | 598 | FIRST LAYER | 7 | 1 | 1883.7 | 1894.8 | 0.59 |
| | | SECOND LAYER | 7 | 1 | 1883.7 | 1907.4 | 1.24 |
| | | THIRD LAYER | 7 | 1 | 1883.7 | 1920.0 | 1.89 |

As indicated in TABLE 2, a width Wa of large-width strip plies 26a is made 249 mm and a width Wb of small-width strip plies 26b is made 166 mm, whereby a ply member 28 built using respective integral numbers of strip plies 26a, 26b is wound round respective building drums, which are used for tire sizes of 15 to 22 inches, in a tensioned state with the tensile rate R being equal to or less than 3% to enable building a carcass ply, and besides can be wound in a tensioned state with the tensile rate R being equal to or less than 3% even in case of building second-layer or third-layer carcass plies. Also, a total number of strip plies 26 as used for respective tire sizes can be restricted to 8 or less.

As described above, according to the invention, width dimensions of large-width strip plies and small-width strip plies are appropriately set whereby a ply member can be wound round a whole outer peripheral surface of a building drum, which has an optional outer peripheral length, to build a carcass ply without changing widths of the respective strip plies, and even in case of winding a plurality of ply members to form a carcass layer having a multi-layered structure, the plymembers can be wound round a whole outer peripheral surface of a building drum without changing widths of the respective strip plies. Therefore, it is possible to accommodate for the production of various kinds and small lot, in which tire sizes differ, and there is no need of preparing ply members of various kinds, thus enabling manufacture at low cost.

Also, since the ply member 28 is formed by providing the respective strip plies 26a, 26b with an overlap width P to join the same together, a sufficient bond strength is ensured for the respective strip plies 26a, 26b to enable suppressing breakage of the ply member when the ply member is wound round a building drum in a tensioned state.

### BRIEF DESCRIPTION OF THE DRAWINGS

FIG. 1 is a cross sectional view showing the structure of a pneumatic radial tire according to an embodiment of the invention.

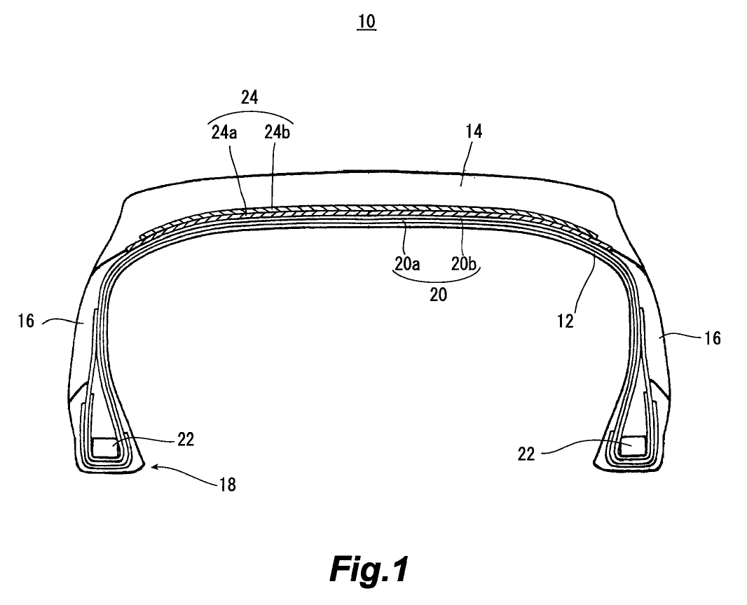

FIG. 2(a) is a plan view showing a ply member and FIG. 2(b) is a side view showing the ply member.

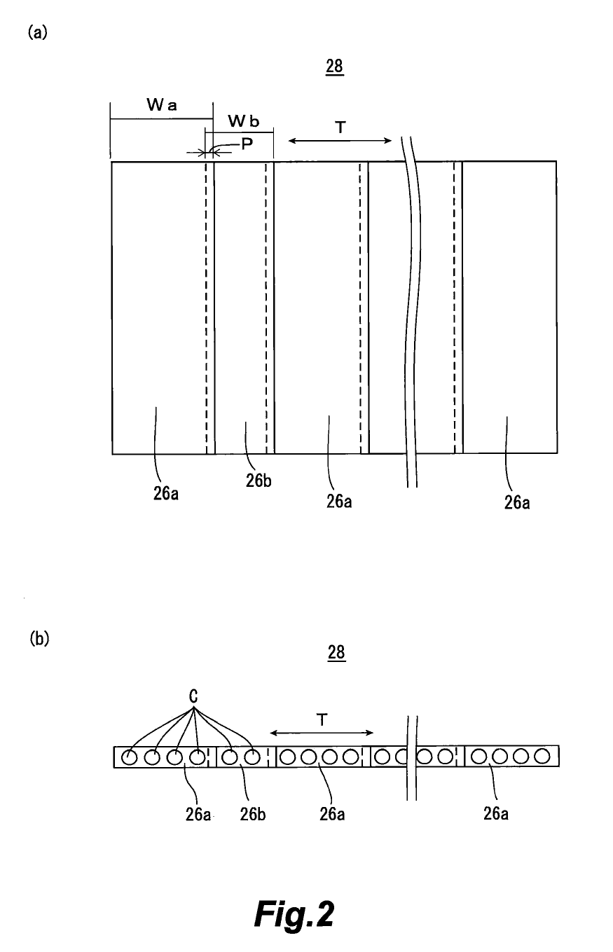

FIG. 3 is a plan view schematically illustrating a method of manufacturing a carcass ply according to an embodiment of the invention.

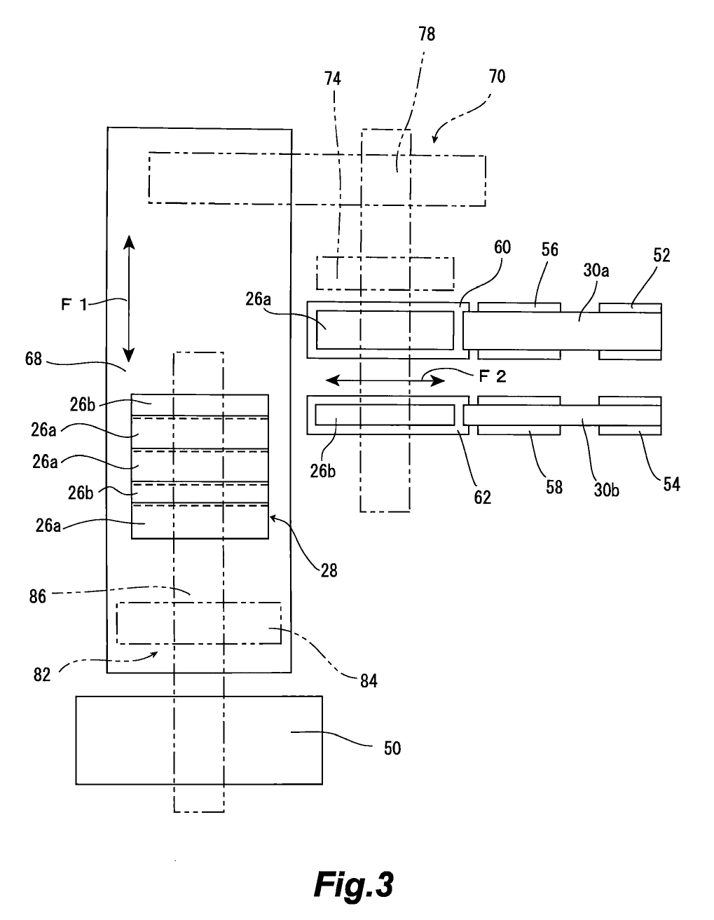

FIG. 4 is a side view schematically illustrating the method as viewed in a flow direction of a sticking conveyor.

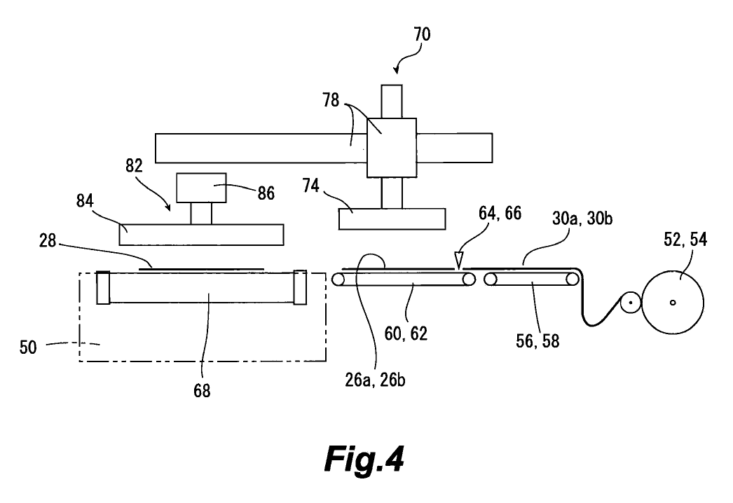

FIG. 5 is a side view schematically showing a building drum and the sticking conveyor.

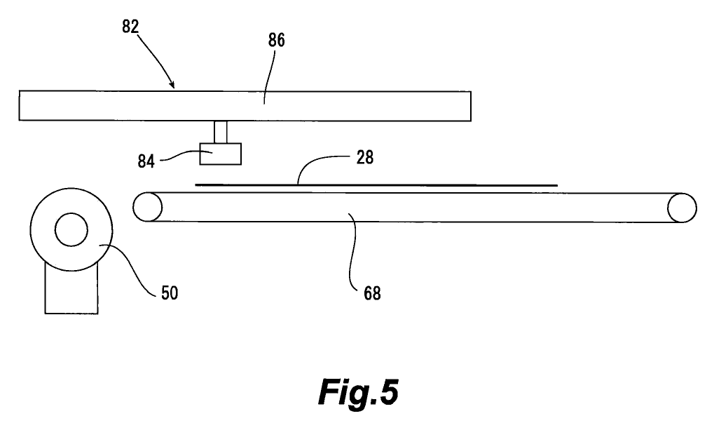

### DESCRIPTION OF REFERENCE NUMERALS AND SIGNS

10: tire
20: carcass layer
20a, 20b: carcass ply
26a: large-width strip ply
26b: small-width strip ply
28: ply member
30a: large-width ply base material
30b: small-width ply base material
50: building drum

1. A method of manufacturing a carcass ply, which constitutes a carcass layer of a tire, the method comprising
standard-length cutting a large-width ply base material and a small-width ply base material, which have different width dimensions, using a plurality of strip plies being at least one of large-width strip plies and small-width strip plies thus obtained, joining non-cut surface sides of the respective strip plies to build a band-shaped ply member, and winding the ply member round a building drum in a tensioned state, in which the tensile rate is equal to or less than 3%.

2. The method of manufacturing a carcass ply, according to claim 1, wherein the non-cut surface sides of those strip plies, which constitute the ply member, are joined in a state of overlapping together a predetermined amount.

3. A pneumatic radial tire using the carcass ply according to claim 1 or 2.
